(19) United States
(12) Patent Application Publication
(10) Pub. No.: US 2011/0194717 A1
(43) Pub. Date: Aug. 11, 2011

(54) HEARING AID WITH EXCHANGEABLE SHELL PARTS AND WIRELESS COMMUNICATION

(75) Inventors: Jacob Holdt Hansen, Smorum (DK); Jan T.L. Larsen, Smorum (DK); Jakob Sandholt Klemmensen, Smorum (DK); Kenneth Rueskov Moller, Smorum (DK); Carl Christian Nielsen, Smorum (DK); Christian Nielsen, Smorum (DK); Morten Kjaer Petersen, Smorum (DK); Jakob Hager Rasmussen, Smorum (DK); Soren Wichmann, Smorum (DK); Claus Würfel, Smorum (DK)

(73) Assignee: OTICON A/S, Smørum (DK)

(21) Appl. No.: 13/120,803

(22) PCT Filed: Sep. 26, 2008
(86) PCT No.: PCT/EP2008/062951

§ 371 Date: Mar. 24, 2011

(51) Int. Cl. H04R 25/00; H01Q 7/00

(52) U.S. Cl. 381/328; 343/866

(57) ABSTRACT

Hearing aid or audio device having a behind the ear part adapted to rest behind an earlobe of a user and a speaker unit comprising a speaker, whereby the speaker unit is adapted for insertion into the ear of a user, and whereby electric leads are provided between the speaker unit and the behind the ear part, said leads having a connection part opposite the speaker unit for connection with a corresponding socket in the behind the ear part, wherein the exterior and visible parts of the behind the ear part are defined by a generally U-shaped shell element, a battery drawer and a microphone cover plate characterized in that all further inside parts of the behind the ear part are interconnected to form a single sub-assembly and in that said sub-assembly is releasably coupled to the U-shaped shell element between two upright walls thereof by latch-locks provided to interact between the microphone cover plate and the upright wall elements

### AREA OF THE INVENTION

The invention regards a hearing aid with exchangeable shell parts and wireless communication. In modern hearing aids it has become customary that the end user may choose between a large variety of differently coloured hearing aids. And in order that the dispenser who handles the contact with the end user need not invest in a similarly large number of hearing aids, the ability to perform colour versioning of hearing aid styles is becoming more and more usual. To this end hearing aids with exchangeable outer parts such as battery drawer or shell elements have been marketed recently.

Further, hearing aids with various types of wireless communication abilities have become increasingly popular among hearing aid users. It is extremely difficult to establish wireless communication ability in a hearing aid without increasing the size of the hearing aid considerably. Especially the antenna is a problem as it must be kept small and at the same time, due to the small overall size of the hearing aid, be located close to the output element which supplies the sound to the user, and this is a major challenge to the design of the antenna, which is liable to pick up noise from the output stage of the hearing aid where high currents and/or voltage differences are un-avoidable.

### BACKGROUND OF THE INVENTION

The invention provides a hearing aid which makes colour versioning easy and straight forward and also perfomable without the use of any tools. Further, the invention provides a wireless antenna, which is protected against noise, and a hearing aid with such an antenna.

### SUMMARY OF THE INVENTION

According to a first aspect of the invention a hearing aid or audio device is provided, which has a behind the ear part adapted to rest behind an earlobe of a user and a speaker unit comprising a speaker, whereby the speaker unit is adapted for insertion into the ear of a user, and whereby electric leads are provided between the speaker unit and the behind the ear part, said leads having a connection part opposite the speaker unit for connection with a corresponding socket in the behind the ear part, wherein the exterior and visible parts of the behind the ear part are defined by a generally U-shaped shell element, a battery drawer and a microphone cover plate. In order to ensure an easy assembly of the shell part and the remaining inside hearing aid elements, all inside parts of the behind the ear part are interconnected to form a single sub-assembly and this sub-assembly is releasably coupled to the U-shaped shell element between two upright walls thereof by latch-locks provided to interact between the microphone cover plate and the upright wall elements. This allows the sub-assembly of the interior parts such as the transducers and antennas, the battery contacts and the printed circuit with IC devices mounted thereon to remain assembled as one unit when the hearing aid is to be colour versioned. The sub assembly may be removed from the shell part, and introduced into a shell part with a different colour, and to complete the hearing aid the battery drawer is attached to the subassembly and the microphone cover plate is locked into place by means of the latch locks between the cover plate and the upright wall elements of the shell part. All of these operations are performable without the use of external tool parts and take no more than a few minutes to perform, and thereby the dispenser may perform the colour versioning at any given moment during the process of selling the hearing aid to the end user. Further, this allows the hearing aid dispenser to only invest in a small number of the more expensive interior sub-assemblies, and have a large number of differently coloured shell parts between which the user may choose. Also the battery drawer and microphone cover plate may be available in similar colours.

Preferably snap latches are provided on an under-side of the microphone cover plate and corresponding undercuts on the up-right walls of the U-shaped shell element at the inside rims thereof are provided to receive the snap latches of the microphone cover plate. This construction ensures a very safe and secure connection between the microphone cover plate and the upright walls of the shell element, which is necessary to ensure that the hearing aid does not come apart if the user in-advertently drops it on a hard surface, and also the snap-latches and undercuts may be interconnected without use of any further tool elements.

In an embodiment of the invention a wedge shaped recess is provided between the microphone cover plate and the remaining hearing aid, adapted to receive a wedge shaped implement in order to exert an opening force between the microphone cover plate and the hearing aid sufficient to force the snap latches of the microphone cover plate out of engagement with the undercuts of the inside rim of the shell element. A small implement may be used to dis-connect the microphone cover plate from its latched in state with the inside of the shell walls, and if the dispenser has strong finger-nails a finger nail may serve as implement. The wedge shaped recess will ensure, that if only the implement is pressed into the recess in any manner, the microphone cover plate will come off.

In an embodiment a battery drawer is detachably connected to the hearing aid adjacent to the microphone cover plate, and the battery drawer comprise a wedge shaped implement at an edge thereof shaped to fit into the wedge shaped recess between the microphone and cover plate. By this special construction of the battery drawer, the taking apart of the hearing aid may be performed without any external tools and without demanding efforts on the parts of fingernails of the person performing dis-assembly of the hearing aid.

In an embodiment of the invention a wireless antenna is provided shaped as a coil and comprising:
an insulated electrically conductive wire wound in parallel coaxial windings defining a coil axis thereby adapted to transduce between changes in a magnetic field inside of the coil and electric power in the coil windings whereby further
a shield adapted to prevent electric fields from reaching the antenna is provided externally of the coil. According to the embodiment of the invention the shield in the direction transversely to the direction of the coil axis comprise at least two layers of electric leads and further the leads are interconnected, spaced apart and in each layer has a main direction of extension which is coaxial with the axis of the coil.

By providing two layers of leads, having a main direction of extension which is coaxial with the axis of the coil, the screen may be made with very densely packed leads to ensure that electric fields from nearby circuit elements do not reach the coil and disturb the transducing in the coil between magnetic field a and electric power in the winding of the coil.

In a preferred embodiment each lead in a first layer is placed to cover open space between leads in a second layer and vice versa. In this way electric fields will be prevented from reaching the coil by either the first or the second of the two layers of shielding leads.

Preferably the leads transversely to their main direction of extension in a layer are wider than the space between two consecutive leads in the layer. In this manner it is ensured that there is always overlap between the leads in the two layers perpendicular to the layers, especially when production tolerances are taken into consideration.

Preferably the wire wound up to form the coil at each end of the coil is connected to a printed circuit board, and the leads of the shield are connected to the same printed circuit board. The shield shall have to be connected to what is defined as zero potential on the board in order to ensure the best effect of the shield.

The invention further concerns a wireless antenna of the above kind which is connected to a circuit board whereby further:
microphones are provided and connected to the circuit board,
an audio processor and audio amplifier is provided on the circuit board,
output connections adapted to transmit an enhanced audio signal to an output transducer for delivering an audio signal to a user perceivable as sound is provided and connected to the circuit board,
power input means adapted to receive power from a battery is provided.

By the provision of the above, a hearing aid or similar audio device may be provided wherein wireless signals may be transduced without disturbance from the hearing aid circuitry.

In a further aspect of the invention a hearing aid or audio device is provided which has a behind the ear part adapted to rest behind an earlobe of a user and a speaker unit comprising a speaker, whereby the speaker unit is adapted for insertion into the ear canal of a user, and whereby electric leads are provided between the speaker unit and the behind the ear part, said leads having a connection part opposite the speaker unit for connection with a corresponding socket in the behind the ear part. Preferably the hearing aid comprise a wireless antenna as defined above. In such a hearing aid wireless signals may be received or transmitted without being effected by noise even if large output voltages are introduced into the relatively long leads between the behind the ear part and the receiver in the ear canal resulting in powerful electric noise fields.

### BRIEF DESCRIPTION OF THE DRAWINGS

FIG. 1 is an exploded view a hearing aid according to the invention viewed in 3d projection,

FIG. 2 shows an enlarged view of the chassis part of the hearing aid in FIG. 1

FIG. 3 is an enlarged view of the microphone cover shown in FIG. 1

FIG. 4 is a line drawing of an enlarged view of the microphone holder part shown in FIG. 1,

FIG. 5 is an enlarged view of the folded flexible print plate shown in FIG. 1,

FIG. 6 is an enlarged view of the battery contact part shown in FIG. 1,

FIG. 7 is an enlarged view of the programming socket shown in FIG. 1,

FIG. 8 is an enlarged view of the output socket shown in FIG. 1,

FIG. 9 is an enlarged view of the shell part shown in FIG. 1,

FIG. 10 is an enlarged view of the battery drawer shown in FIG. 1,

FIG. 11 is a sectional view of the hearing aid in 3d projection,

FIG. 12 is a sectional view of a back end part of the hearing aid,

FIG. 13 is a sectional view of a front end part of the hearing aid,

FIG. 14 shows the hearing aid in 3d projection seen from a fist side, without the outer shell,

FIG. 15 shows the hearing aid in 3d projection seen from a different angle, without the outer shell,

FIG. 16 shows the hearing aid in a 3d projection without the outer shell form yet a different angle,

FIG. 17 shows an enlarged view of the battery spring shown in FIG. 16,

FIG. 18 shows the microphone holder in FIG. 4 in d3 elevated view from below, without microphones mounted thereto,

FIG. 19 shows the hearing aid in 3d view with the “in the ear part” attached thereto and ready for use,

FIG. 20 shows a sectional 3d view of the shell enabling view of internal structures on the shell,

FIG. 21 is the flexprint with most electronic components mounted thereon,

FIG. 22 is a transverse sectional view of an enlarged part of the hearing aid without the outer shell,

FIG. 23 is a 3d projection of the hearing aid without the outer shell and battery drawer to better show the programming socket,

FIG. 24 shows a flexprint lay out of a screen for the wireless antenna,

FIG. 25 is a schematic representation of a section through a first part of the screen,

FIG. 26 is a schematic representation in larger scale of a via in the screen shown in FIG. 24.

### DESCRIPTION OF A PREFERRED EMBODIMENT

In the following a tenon is used to designate a projecting member in a piece for insertion into a mortise to make a joint, and a mortise is used to designate a hole, groove, or slot into or through which some other part of an arrangement of parts fits or passes and fits tightly. In all of drawings 1-23 an icon in the lower left corner appears, which is not part of the invention, but shows the actual 3d projection in the figure in terms of x, y and z directions.

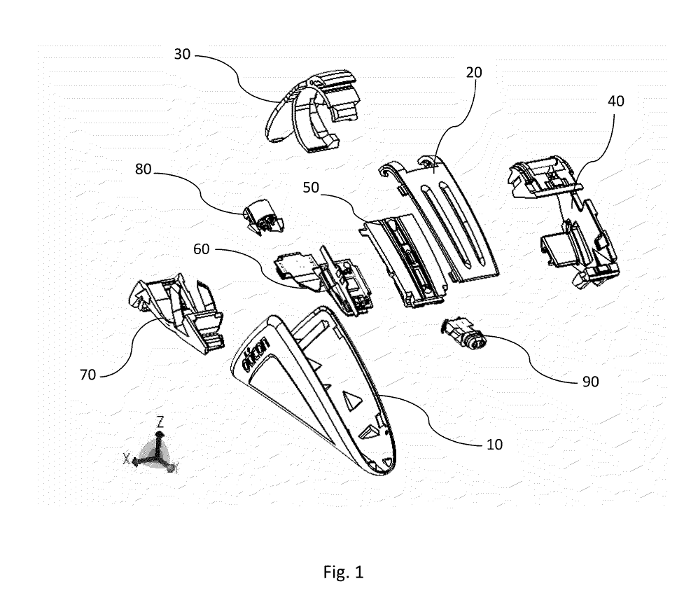

The nine elements constituting the hearing aid shown in FIG. 1 are termed as follows:
outer shell part 10,
microphone cover plate 20,
battery drawer 30,
chassis 40,
microphone holder 50,
flexprint with components 60,
battery contact part 70,
programming socket 80,
output socket 80.

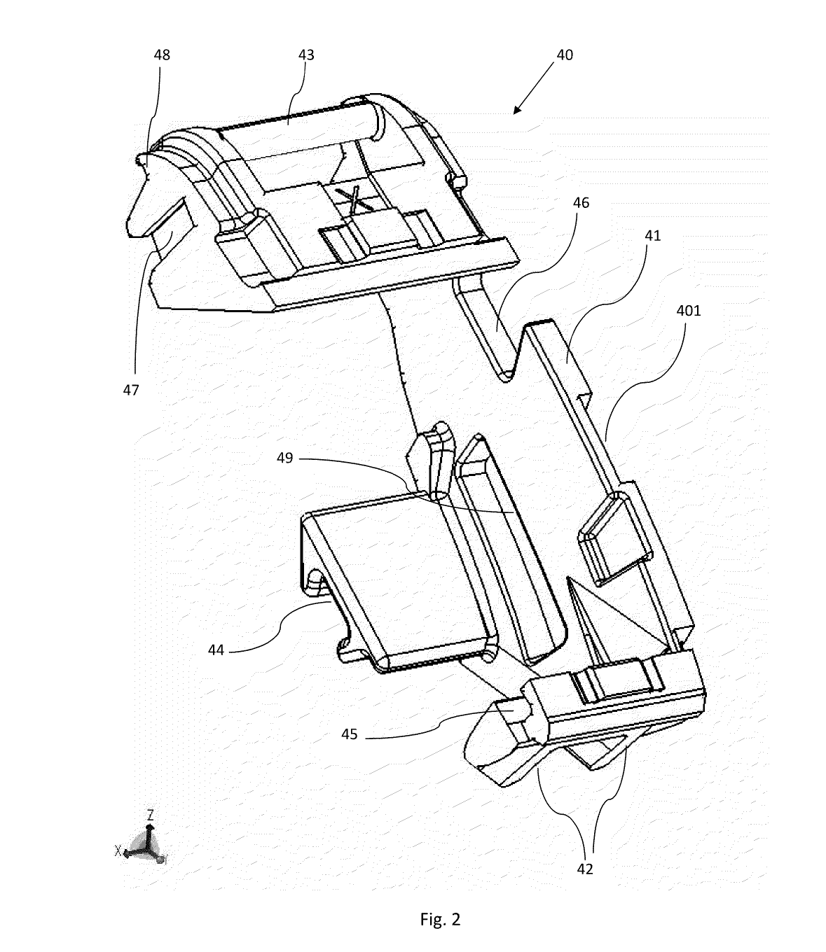

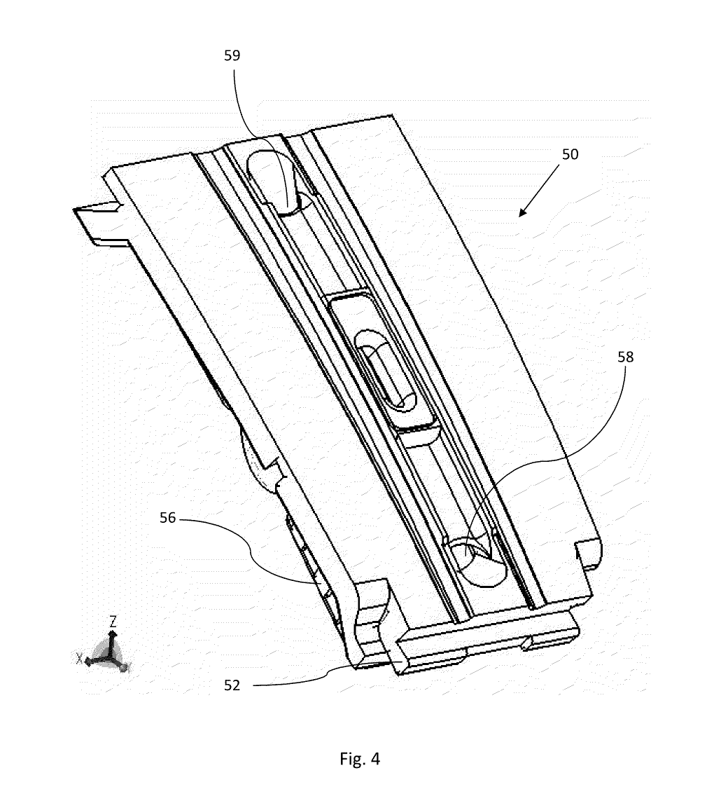

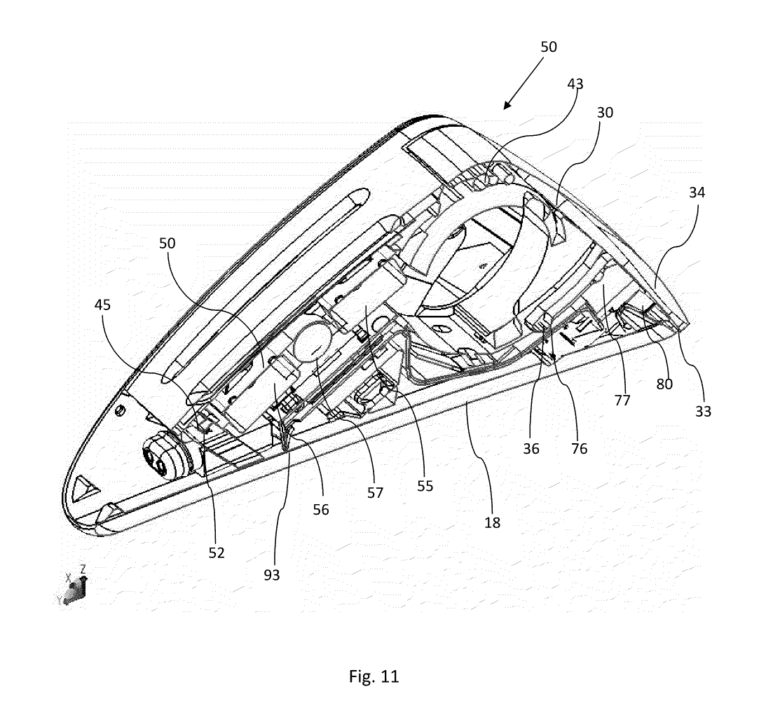

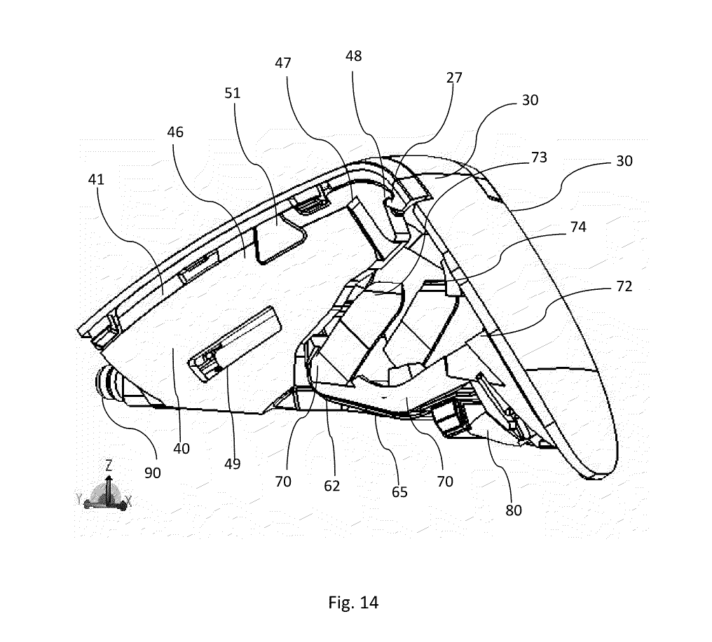

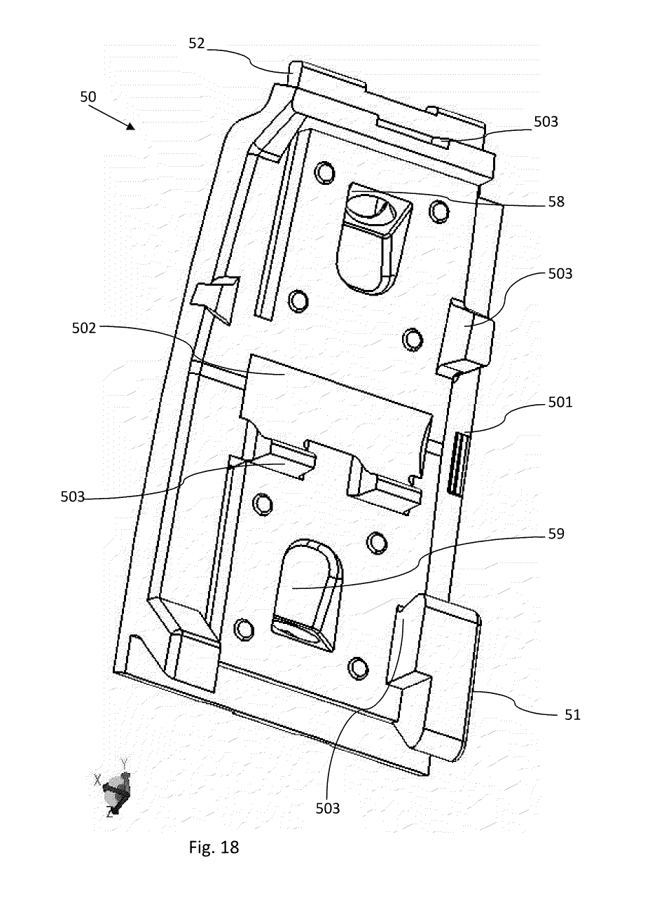

The chassis 40 shown in FIG. 2 is connected with the battery contact part 70, the microphone holder 50 and the outer shell 10 by well known mortise and tenon joints. Integrally with a sidewall 41 tenons 42 for the outputs socket 90, a battery drawer pin 43, and a transverse mortise 44 are provided. Above the tenons 42 for the output socket 80 a mortise 45 is shaped, and a further mortise 46 is provided in sidewall 41, and corresponding to these mortises 45 and 46 transverse tenons 51, 52 are shaped in the microphone holder 50. In FIGS. 14 and 18 the tenon 51 fitting into mortise 46 is shown, and in FIGS. 4, 11 and 18 the tenon 52 fitting into mortise 45 is shown. By sliding the tenons into the respective mortises a dovetail joint is formed between the chassis 40 and microphone holder 50 as seen in FIGS. 14 and 11.

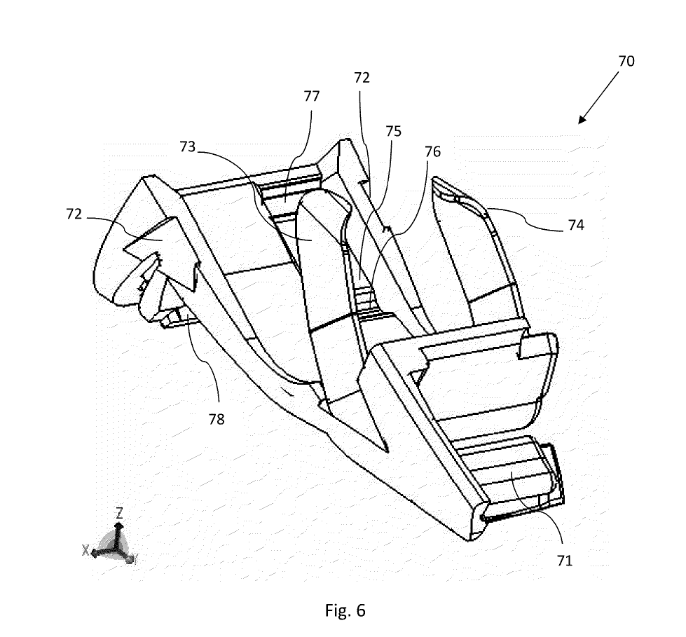

Into mortise 44 tenon 71, shaped with battery contact part 70 and shown in FIG. 6, fits such that battery contact part 70 and chassis 40 may be interconnected. In chassis 40 a further mortis 47 and in battery contact part 70 a mortis 72 is provided in both sides of the parts. These mortises 72 and 47 are aligned, when the chassis 40 and the battery holder 70 are interconnected, in order for the two parts to be able to slide together into the shell 10 and receive the tenons 11 provided on opposed internal sides of the shell 10.

The battery drawer 30 comprise a groove 31 with a baring 32 for the battery drawer pin 43, a construction which allows the battery drawer to be pressed onto the battery drawer pin, whereby a hinge action between the pin 43 and the baring 32 may be realised. This allows the battery drawer 30 to pivot around the pin 43 for exchange of the battery 100, and also the battery drawer 30 is detachable from remaining hearing aid and may be simply pulled off the hinge pin 43.

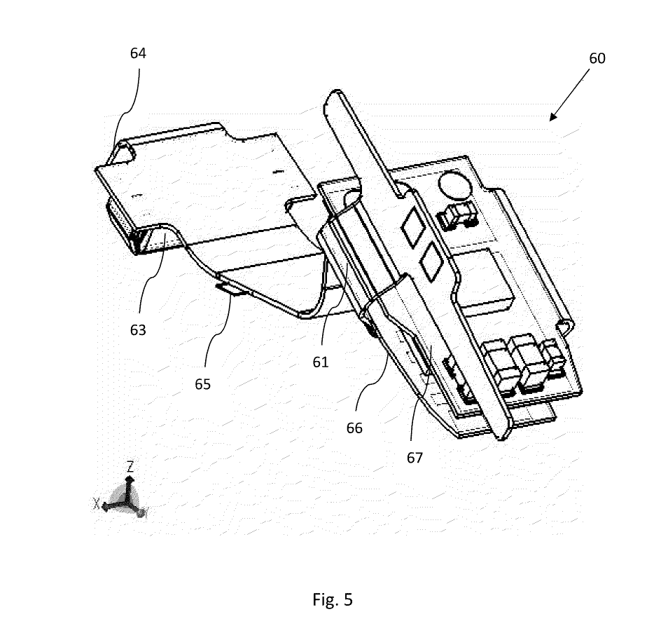

An elongate hole 49 is provided in wall part 41 in order to provide space for a fold in flexprint 60, the fold providing connection between base part 66 and the panel 67 of the flexprint 60 as seen in FIG. 5.

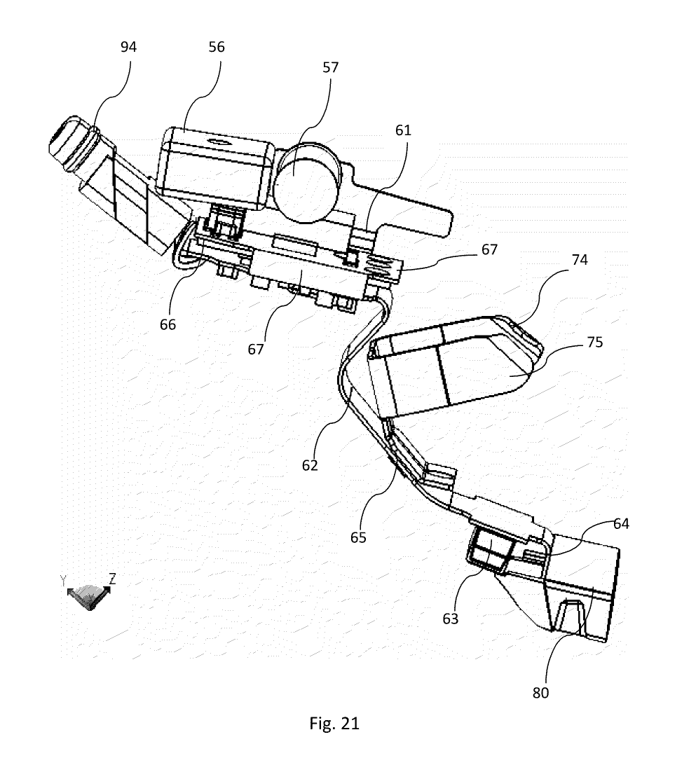

Between the microphone holder 50 and the battery contact element 70 the flexible print plate 60 with electronic components mounted thereon is located, as seen in FIGS. 15, 5 and 21. The electronic components comprise passives such as capacities and active components such as IC devices which through electrically conductive lanes in the flexible print plate and solder connection are interconnected to provide the hearing aid functionality of the device. The flexible print plate, also termed flexprint 60 in the following, is connected to the microphones 55, 56, to the battery connection springs 73, 74, to the output socket 90 and the programming socket 80. Also connected to the flexprint 60 two coils 57, 63 for wireless transmission purposes are provided as described in the following. The flexprint 60 and the components to which it is connected is best seen in FIG. 21.

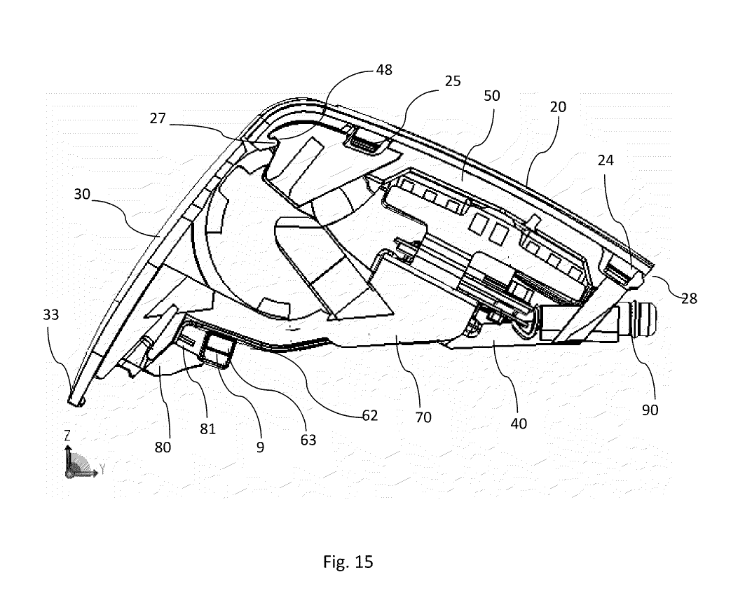

Between the two microphones 55, 56 a telecoil 57 is provided and these three components are mounted to the underside of the microphone holder 50. In FIG. 21 one of the microphones is omitted to get a better view of upright extension 61. The flexprint 60 comprise an upright extension 61 with solderpoints thereon for contacting the three transducers 55, 56, and 57. A downsloping extension 62 is further provided, which gains access to the pins of the programming socket 80, the battery springs 73,74, and the wireless connection coil 63. As best seen in FIG. 15 the pins 81 of the programming socket 80 extend through holes in the outer end 64 of the downsloping extension 62 of the flexprint 60 and are further soldered thereto. A part of each battery spring 73, 74 is embedded in material of the battery contact part 70 and in the area where the flexprint downsloping extension 62 runs parallel to the lower surface of the battery contact part 70 a solder connection pad 65 is provided. This pad 65 is seen in FIGS. 5, 21 and in FIG. 14. The spring 73 comprise a leg which is embedded in battery contact part 70, and this embedded part surfaces at the underside of the battery connection part 70 in order to allow a solder connection at the pad 65 to the flexprint 60. At the opposed spring 74 a similar connection is provided. In FIG. 21 the springs are shown without the material in which they are embedded.

The flexprint comprises sheet like relatively flexible and foldable material and has a lay out with generally rectangular base section 66, a narrow flap extending transversely from a first edge part of the base section 66 and folded to form the upright extension 61, a broader flap extending transversely from a second edge part of the base section 66 in the opposite direction there from and folded upwards and around to form a panel 67 arranged in parallel relationship to the base section 66 as shown in FIGS. 5 and 21, and finally a longer flap extending from a third edge part and forming the downsloping extension 62.

As seen in FIG. 21 the flexprint 60 has mounted thereon a coil 63 close to the end of the downsloping part 64 thereof. The coil 63 works to receive and transmit electromagnetic energy whereby the hearing aid may communicate wirelessly with remote devices such as a further hearing aid being placed on an opposite ear of the user or to/from a third device operated by the user such as a remote control or a streamer for transmission of audio signals to the hearing aid from devices such as telephones and MP3 players. The coil 63 comprise a core made of a material such as a ferrite and an isolated conductive wire wound about the core in a continuous winding forming multiple essentially parallel loops, and at each end of the coil, the two ends of the wire are soldered to solder pads in the flexprint 60 whereby the coil will be in electric communication with IC devices also connected to the flexprint 60. The coil is designed to transduce between electric current in the winding and a magnetic field. Such a coil is sometimes referred to as a solenoid. If an electric current is provided in the coil, a magnetic field will be emitted from the coil, and if the magnetic field in the coil is changed due to outside influence a current/electric potential is generated in the winding. Electronic filtering and amplification is provided in components mounted on the flexprint, and tuned to the size and lay out of the coil in order that sensitivity of the wireless signalling provided through the coil is enhanced in a certain frequency range.

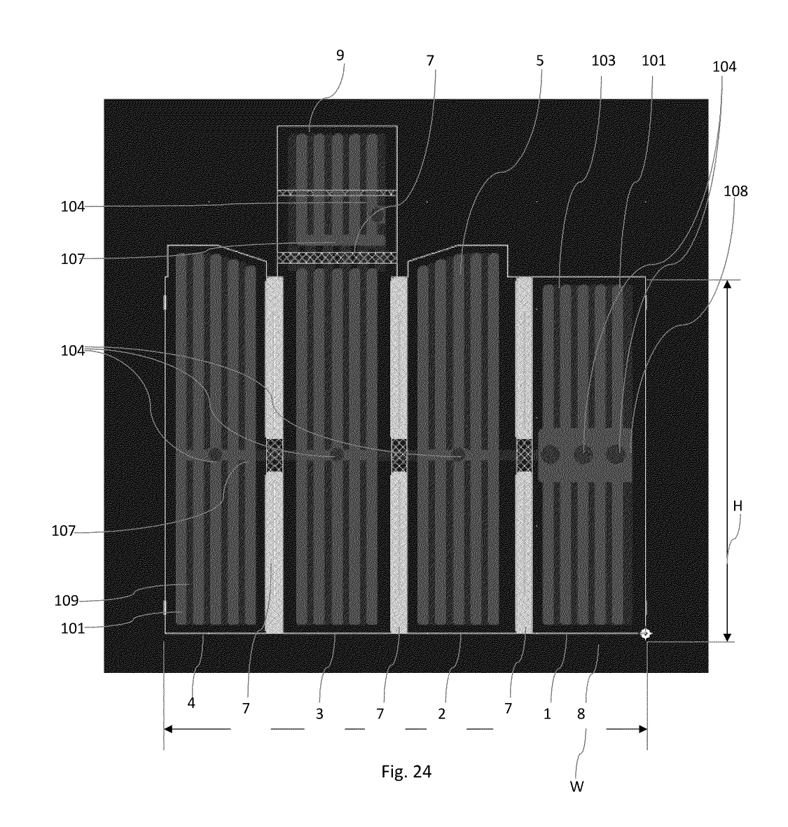

The coil as described above will also respond to changes in the electric field to which it may be exposed and in the hearing aid application described here, the signals generated in the coil due to exposure to electric fields are regarded as noise, and under some conditions this noise may reach a level where it has detrimental influences on the sensitivity of the coil when exposed to changing magnetic fields. This is especially so due to the connection to the output receiver, which for practical reasons remains un-shielded. In order to solve this problem the coil has a screen attached to the surface thereof which will dampen the effect of the changing electric fields. Usually the audio output transducer is a speaker, but any device such as a cochlear electrode, or a bone vibrator are known in connection with hearing aids to produce an output perceivable by the user as sound and all of these devices will lead to noise signals in the coil. As known in the art, the screen comprises a flexprint foil, with a pattern of conductive leads provided therein. In order to not disturb the changes in the magnetic field, the leads in the screen are provided to extend generally in a direction perpendicular to the axis of the individual windings of the wire of the coil. Ideally the electric disturbing fields may be prevented from reaching the coil simply by providing an un-broken layer of electrically conductive material around the coil, but unfortunately such a layer will also dampen the changes in the magnetic field due to the generation of eddy currents in such a layer when exposed to changing magnetic fields. To avoid the eddy currents the leads needs must be split into narrow traces with non-conductive space between individual traces. In FIG. 24 an example of a screen 5 provided in a flexprint material is shown. The line 8 defines the circumference of the print. The screen 5 comprises four panels: a solder panel 1, a second panel 2, a third panel 3, and a fourth panel 4, where each panel is interlinked to neighbouring panel or panels through folding zones 7. In the folding zones 7 usual provisions to ensure that the flexprint material may be folded along a line without cracks forming in possible leads in this area are used. Such provision may comprise cut outs in the panel, in which case the area 7 defines holes in the panels, or alternatively only the cupper layers of the screen are omitted in this area. Each of the four panels 1,2,3,4 are generally rectangular in shape, and has a long side approximately equal to the length of the coil 63 and a short side or end portion equalling the size of the coil. In this way the four panels are foldable in order to form a square box around the coil 63 to ensure screening on all sides thereof. An end panel 9 is provided extending away from an end part of the third panel 3. This end panel 9 is adhered to the third panel 3 by a folding zone 7. The end panel 9 shall be folded down to cover the end of coil 63 as seen in FIG. 15.

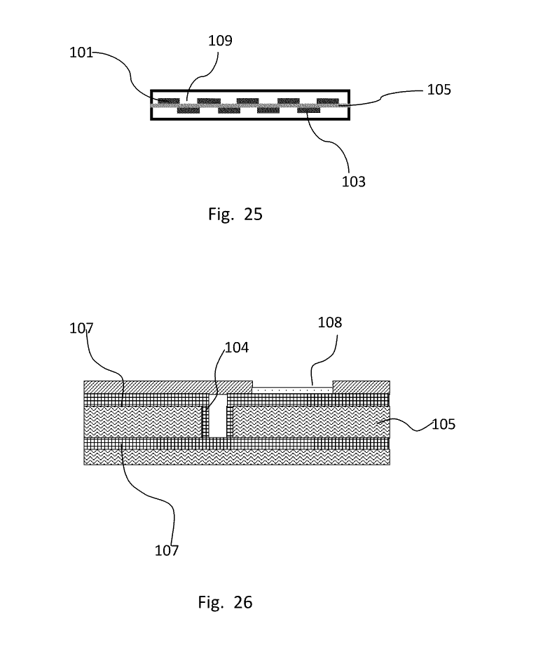

Longitudinally extending spaced apart and generally parallel leads or traces 101 are provided on all panels. By the spaced apart provision of the leads 101, openings 109 between the leads are provided and the openings 109 are necessary in order to avoid the eddy currents, however, they also diminish the benefit of the screen, as the openings 109 allow some of the electric fields to enter through the screen whereby noise currents are generated in the coil 63. The flexprint used for the screen is therefore provided as a two layer print, and in FIG. 25 a schematic representation of a section through a panel is shown. The panel has an upper layer of electrically conductive traces or leads, with individual traces 101 thereon, and a lower layer of electrically conductive traces, with individual traces or leads 103 thereon. The upper traces 101 are shown in white in FIG. 24 and the lower traces 103 are shown in gray shading. In FIG. 25 both set of traces are schematically indicated in black. Each trace 101 in the upper layer is placed to cover space between traces 103 in the lower layer and vice versa, and in order to effectively shield off the noise it is important that in the direction perpendicular to the screen there are no openings between leads. To this end the leads are somewhat wider than the space between the leads in a layer. The leads provided in the shown example have a width of 100 μm and the space between leads is 60 μm. Given the manufacture tolerances of such printed boards, this layout of leads and space ensures that there are no openings perpendicular to the flexprint which are not covered by at least one layer of electrically conductive material connected to ground. The thickness of the traces is about 12 μm. An insulation layer 105 is provided between the two sets of traces as seen in FIG. 25. In FIG. 24 the dots 104 represent an electrically conductive path between the two layers of traces, traversing the insulation layer 105. The traversing path 104 is placed on a transversal lead 107 which in both the upper layer and the lower layer of traces is provided in order to interconnect individual traces, and in the first panel 1, a solder pad 108 are provided. The solder pad is provided to ensure connection between the ground plane in the flex print 60 and all leads in the screen 5 in the flexprint. The total size of the flexprint is indicated by arrows W and H in FIG. 25. For the coil in question W will have to be between 4 and 5 mm and more specifically 4.4 mm. H has a size between 3 and 4 mm and preferably 3.3 mm which corresponds to the length of the coil 63.

A more detailed section through the flexprint screen is shown in FIG. 26. In this figure both a traversing path 104 and a solder pad 108 are shown. The insulation layer 105 and the upper and lower transversal lead 107 is disclosed also. The insulation layer 105 is about 20 μm in thickness.

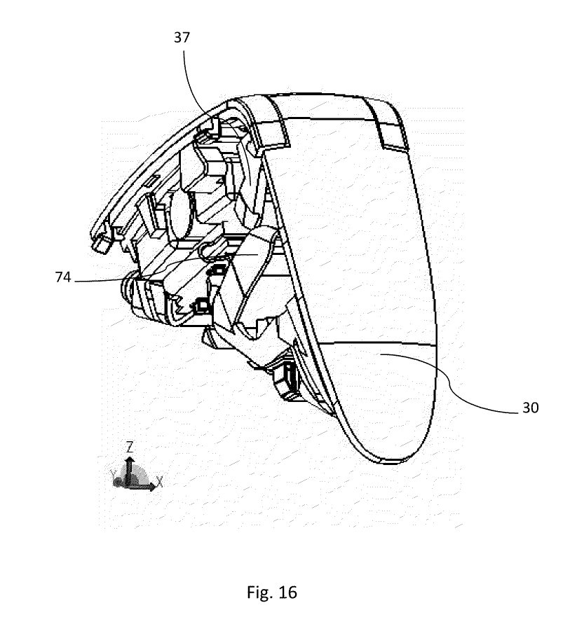

The coil and flexprint screen are adapted for an un-balanced amplifier, where the electrical potential generated in the coil is measured or provided between a ground plane or zero potential and the deviation therefrom caused by changes in the magnetic flux at the coil location. This implies that one end of the winding on the coil is connected to the zero potential of the device and the other end is connected to an input and/or output terminal of the IC device. The terminal of the winding connected to the input/output terminal of the IC device is the most sensitive to noise generated in other parts of the device, and to provide better screening of this terminal, the extra panel 9 is provided such that it may be folded to cover this terminal or in effect the entire end part of the coil 63 as seen in FIG. 15. As seen in FIGS. 16 and 21 and 23 the other end of the coil 63 remains un-protected.

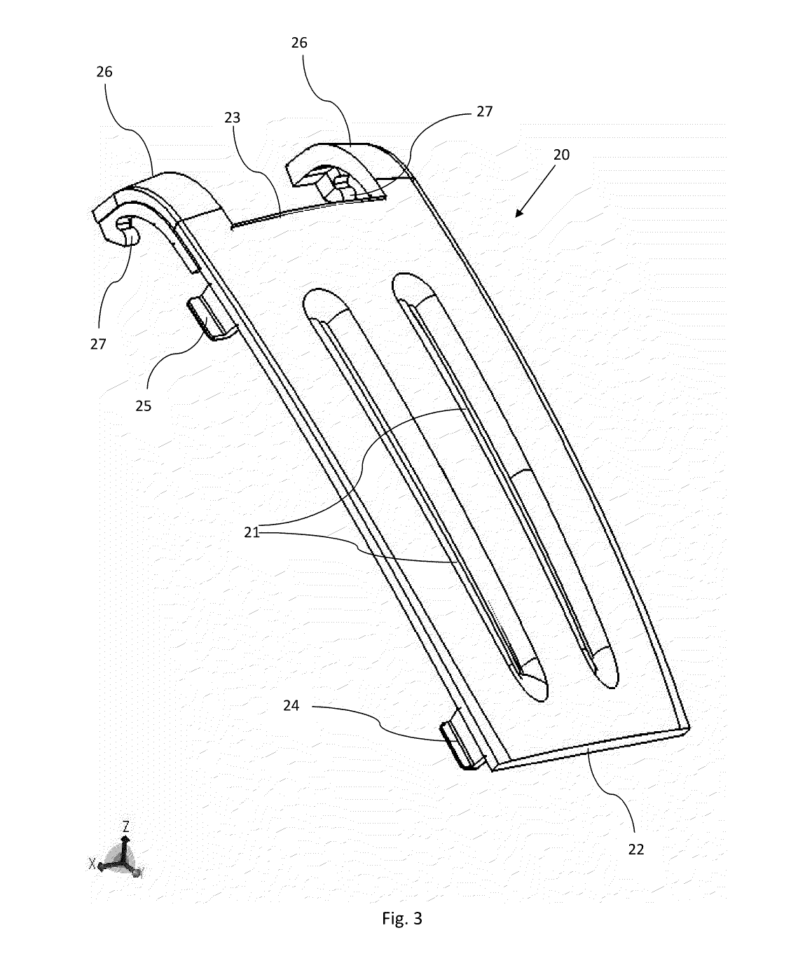

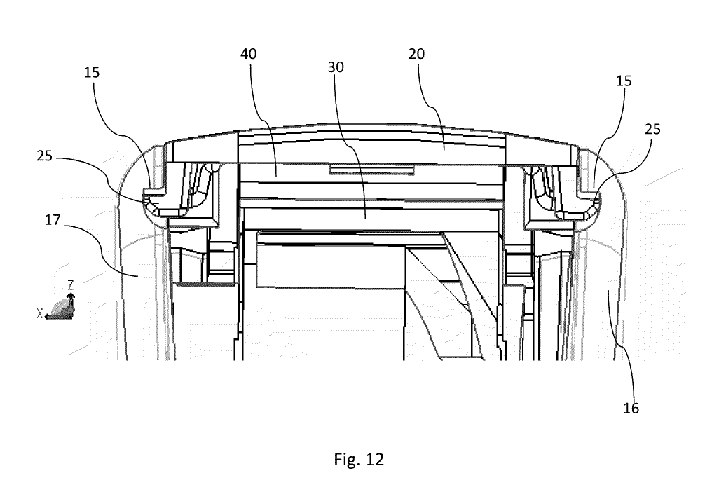

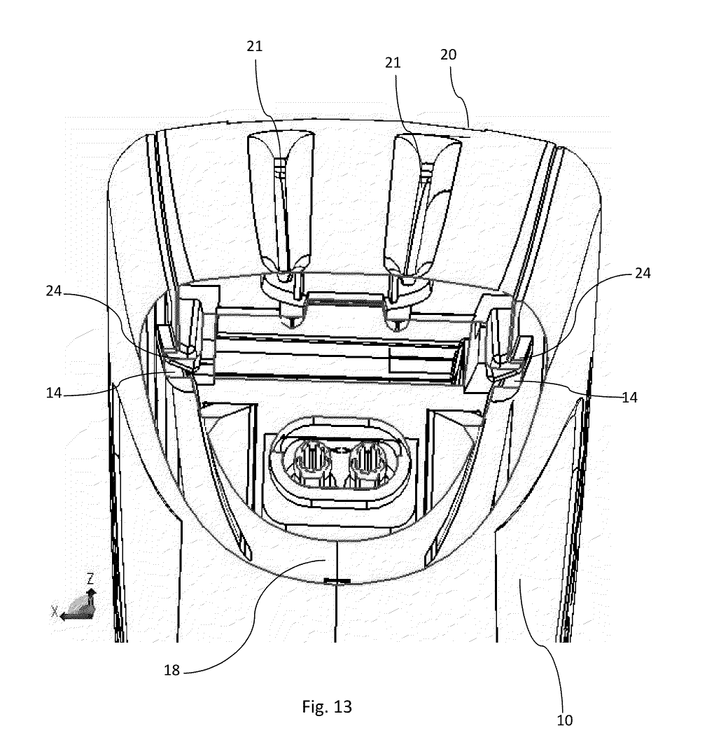

In FIG. 3 the microphone cover plate 20 is shown, and the plate 20 has a generally rectangular shape with long and short sides. Sound inlets are provided as slit formed openings 21 through the plate 20 provided in parallel with the long sides. The plate 20 has a front end 22 and a back end 23, and at the front end 22 along the long sides opposed snap projections 24 are provided as best seen in FIG. 13. The pair of snap projections 24 corresponds to recesses 14 provided in the shell part 10. Similar snap projections 25 are provided at the back end 23 along the long sides as seen in FIG. 12. This pair of projections 25 corresponds to recesses 15 provided in the shell 10. At inner sides of the snap projections 25 and 24, open space is provided in microphone holder 50 and chassis part 40, to allow for the snap projection to snap into and out of engagement with the recesses 14 and 15 of the shell part 10. At the back end 23 of the microphone cover plate 10 hooks 27 are shaped at the tip of a pair of fork like projections 26 extending downwards on each their side of the battery pin 43 when the cover plate 20 is in place. The hooks 27 grip into complimentary recesses 48 of the chassis part 40.

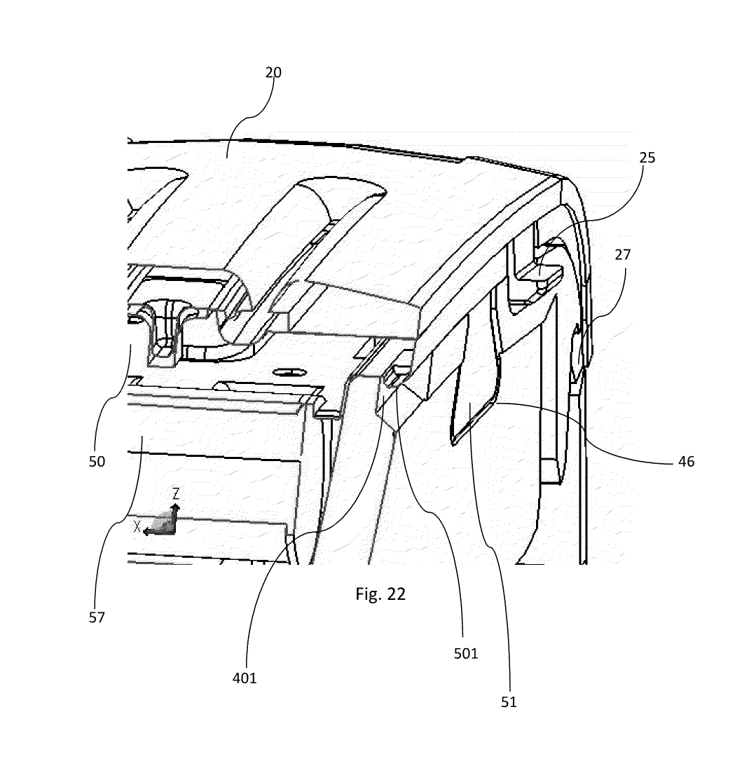

The microphone holder 50 is shown in detail in FIG. 4. The sound input system of which the microphone holder 50 is a part, comprise two holes 58, 59 leading through the holder 50 and provided to feed sound entered through the slits 21 of microphone cover plate 20 and into the microphones 55, 56 of which only microphone 56 is visible in FIG. 4. The sound input system is described in detail in our co-pending U.S. published patent application Ser. No. 11/515,802 which is hereby incorporated by reference. FIG. 18 shows the microphone holder 50 from below and here the through holes 58 and 59 can be seen and rectangular microphone mounting planes are provided around each of the holes, such that microphones may be glued or cemented onto the mounting plane to obtain a sound tight seal between a sound inlet hole in each microphone and respective holes 58, 59. As previously explained the tenons 52 and 51 are also visible in FIG. 18. When the microphone holder 50 and the chassis part 40 are joined, a snap edge 501 on the microphone holder is provided to snap into a recess 401 on the chassis wall 41, such that the two elements interlock and do not inadvertently come apart during handling in a dispenser shop or during manufacture. This feature is best seen in FIG. 22.

As seen in FIG. 18, a rounded recess 502 is provided in the microphone holder between the two microphone mounting planes and this recess receives the coil 57. Support planes 503 for guiding the placement of microphones and the coil are also provided on microphone holder.

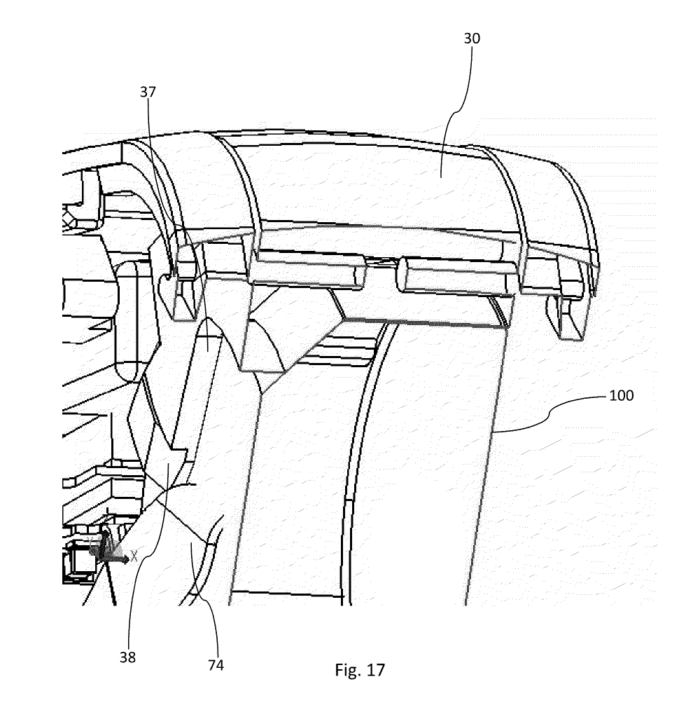

The battery contact part 70, shown in FIG. 6, comprise a cam surface 75 having two arrests, a closing arrest 76 and an off arrest 77, as also seen in FIG. 11. A cantilever 35 with a cam contact 36 (see FIG. 11) is provided at the battery drawer 30 and when the drawer is pivoted about the hinge pin 43, the cam contact 36 will slide along the cam surface 75 and when the battery drawer 30 is closed, the cam contact 36 will come to rest in the closing arrest 76 which keeps the battery drawer from inadvertently being opened. When an opening force is applied to the outer lid part 33, the cam contact 36 will be forced out of the arrest 76 and slide along the surface 75 until the arrest 77 is reached and the cam contact 36 will come to rest in this arrest. In this position of the battery drawer 30, the battery spring 74 has been lifted off the battery 100 and the hearing aid is now disconnected from the battery 100. This is caused by a strut 37 (see FIG. 16), which is made integrally with the battery drawer 30. When the battery drawer 30 pivots around the hinge pin 43 from the closed position towards an opened position the strut 37 will be interposed between the battery spring 74 and the battery 100 which is best illustrated by FIG. 17. The strut 37 comprises a wedge shaped outer end 38 which is shaped to slide in between the battery 100 and the battery spring 74. In this way the user may turn off his hearing aid by partially opening the battery drawer 30. If a further opening force is applied to the end part 33 of the battery drawer 30, the drawer opens up, and the battery 100 may be exchanged if needed.

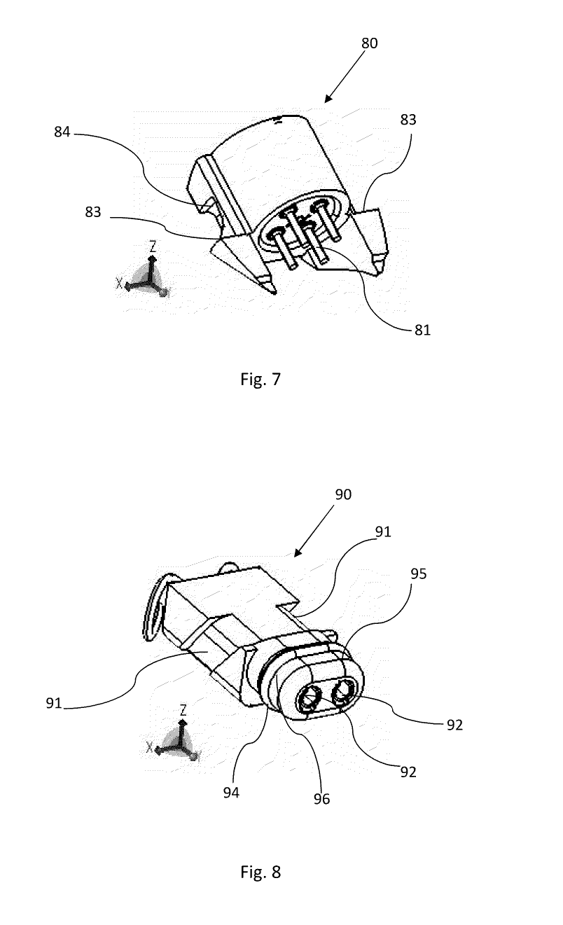

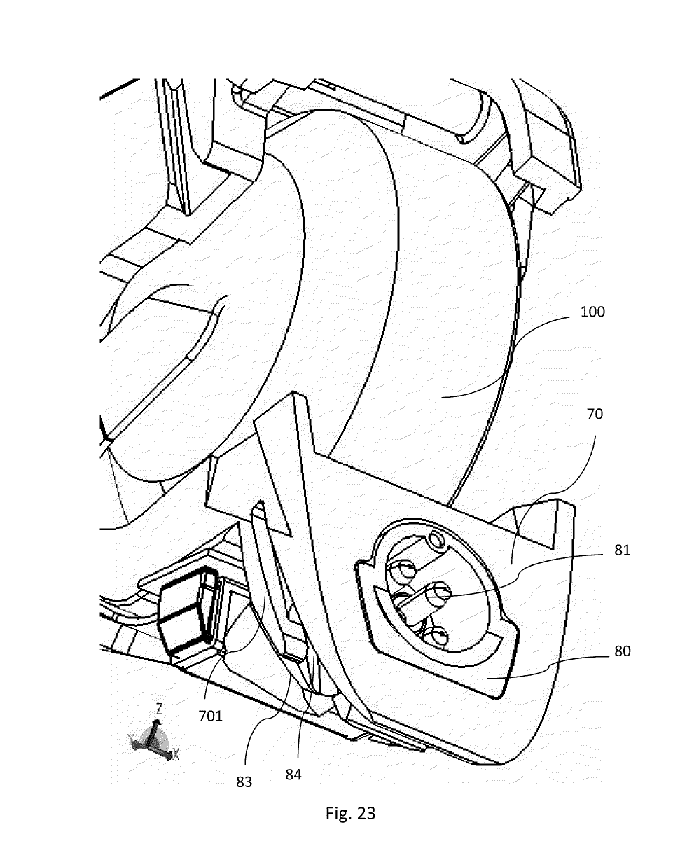

The programming socket 80 shown alone in FIG. 7, resides in a receiving opening 78 of the battery contact part 70. In FIG. 23 the socket is seen in the hearing aid and in an enlarged 3d projection and viewed from the backend without the battery drawer 30 and the shell 10. The four connection pins 81 are embedded or fastened in the material of the programming socket 80 and in FIG. 7 they are all visible from a viewpoint within the apparatus, whereas the same pins are visible in FIG. 23 from a viewpoint outside of the apparatus. A jack (not shown) fitting into the socket disclosed in FIG. 23 may gain contact with all four pins 81. In this way an external device eg a computer or the like may be connected to the IC devices provided on the flexprint, and programming signals which defines the amplification and other signal processing parameters of the hearing aid may be transmitted to the IC devices. The socket 80 comprise retaining surfaces 83 arranged to cooperate with corresponding surfaces 701 on the battery connection part 70 such that when the socket 80 is introduced into opening 78, it will be arrested in the right position. Further, mortises 84 are provided which will receive tenons 12 provided in the shell part 10 when the socket 80 along with the remaining internal parts of the hearing aid is introduced into the shell part 10. The tenons 12 ensures that the socket remains in place when the programming jack (not shown) is introduced and extracted from the pins 80.

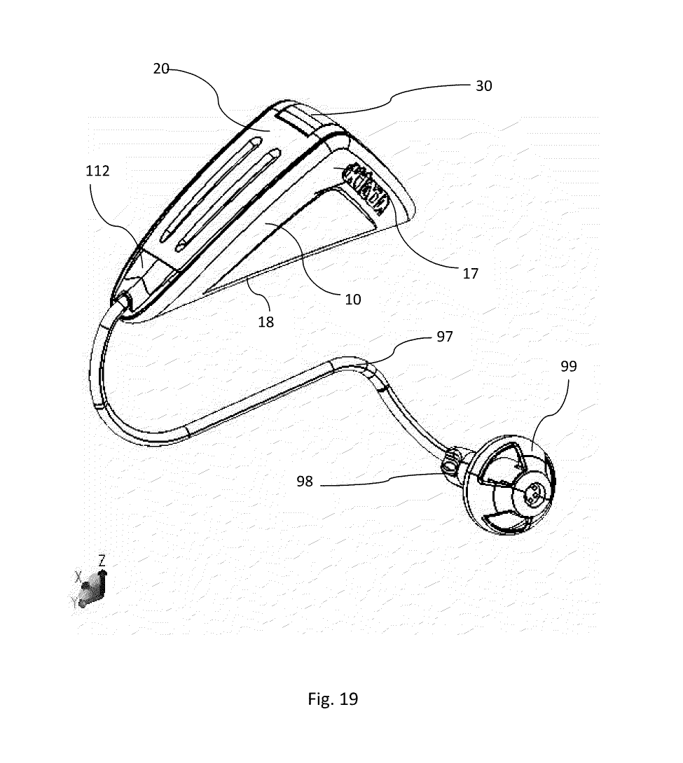

The output socket 90 shown in FIG. 8 has mortises 91 on each side, which corresponds to tenons on the chassis part 40, such that the output socket 90 is slidable into an interlocking joint with the chassis part 40. Two elongate metal bushings 92 are placed in two corresponding holes in the socket, and flexible leads 93 (seen in FIG. 11, 15, 21) are inserted and pinched inside the bushings 92. The leads 93 are at their other end soldered at solder points to the flexprint 60 at the base part 66 thereof. The socket 90 is composed of a rounded front part 95 which will be visible at the front of the hearing aid as seen in FIG. 19 only when the receiver connection jack 112 is not in place. In a groove 96 arranged in the front part 95 an o-ring 94 is provided. In FIG. 19 the hearing aid is shown with the receiver 98 connected through a connector 97 to the jack 112. As seen the jack 112 is plugged into the output socket 90. In this way the shell part with all hearing aid elements may be placed at or behind the ear of a user, and the receiver casing 98 inserted into the outer reach of the ear canal and sounds picket up by the microphones will be enhanced by the signal processing performed in the IC device and output to the receiver and presented at the ear canal. A soft retainer 99 is provided at the outer end of the receiver casing and will retain the receiver casing in a correct position within the ear canal. The retainer is here disclosed as a relatively open element, but as known in the art more or less closed domes may be used, in order that higher sound output levels may be presented to the ear without causing problems of feed back. Also it is possible as well known in the art to provide a costume made ear plug into which the receiver fits tightly, and in this way even higher sound output levels may be presented inside the users ear canal without causing feedback problems.

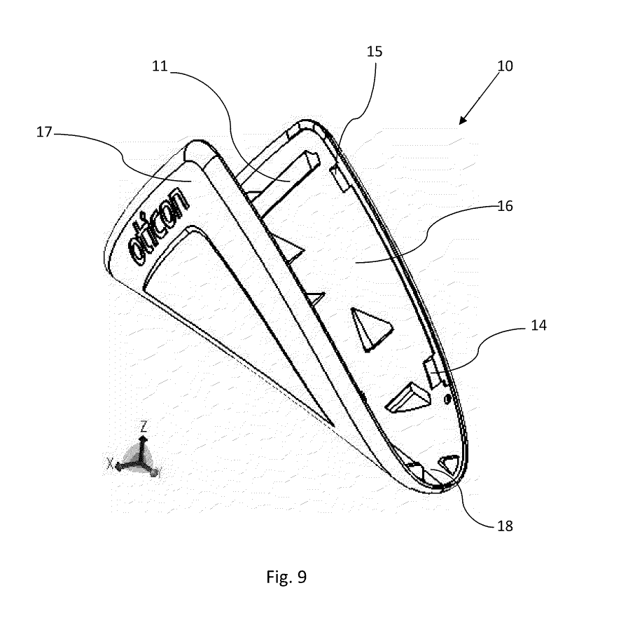

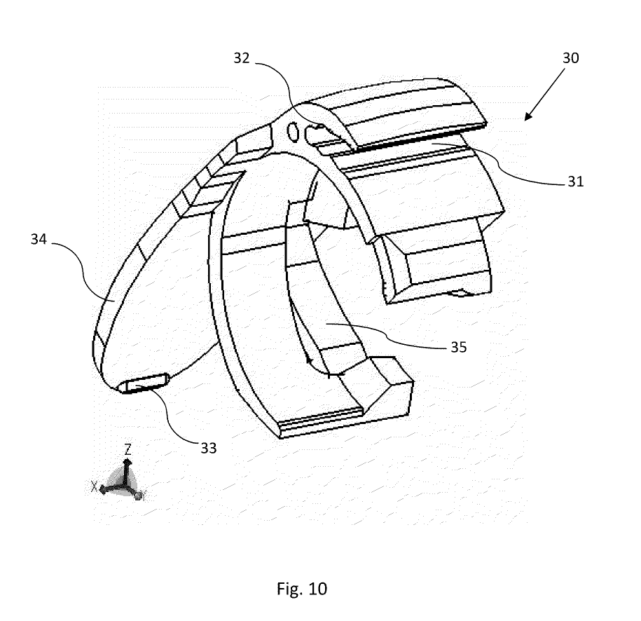

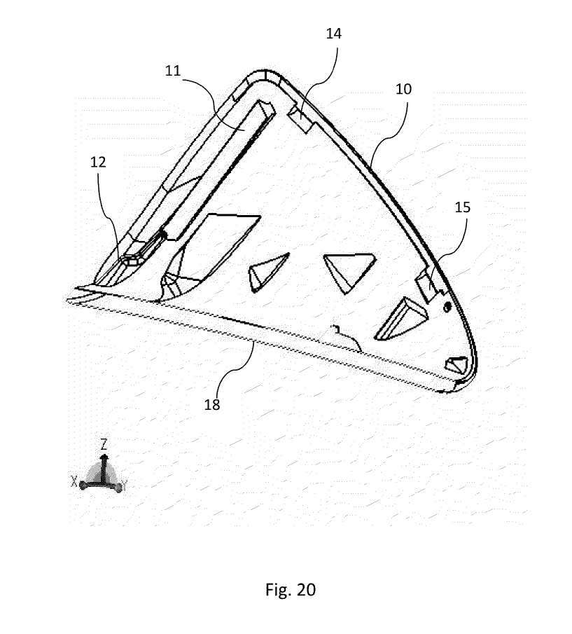

As best seen in FIG. 9 the shell 10 is a one-piece plastic part and is composed of two generally triangular and upright opposed walls 16, 17 and a curved connecting part 18. As seen in FIG. 13 in cross section transversely of the apparatus the connection part 18 follows a smooth and rounded curve, and in the cross section lengthwise of the apparatus seen in FIG. 20, the connecting part 18 is generally straight. The internal parts of the hearing aid are initially assembled and then together introduced in a sliding action in between the upright walls 16, 17 guided by tenon 11.

When the hearing aid is to be assembled, the chassis 40 with the microphone holder 50, battery contact part 70, the flexprint 60 in place there between, the output socket 90 mounted in the chassis and the programming socket 80 fastened to the battery contact part are introduced, as a collected sub-assembly, into the shell 10, guided by the tenons 11. Following this, the microphone cover plate 20 is mounted in that the hooks 27 are introduced into recesses 48 and the cover plate 20 is pivoted down to introduce the snap projections 24, 25 into the recesses 14, 15 of the shell. In this fashion the cover plate firmly locks down all the components of the hearing aid between the two side elements of the shell. The hooks 27 ensure a very easy assembly, such that when the hooks 27 are introduced in the recesses 48 the four snap projections will snap into their respective recesses in a simple and controlled pivotal action between the shell 10 and the microphone cover plate 20.

At last the battery drawer 30 is attached to the battery drawer pin 43 by pressing the groove 31 onto the pin 43 until the baring 32 snaps onto the pin 43, where after the battery drawer 30 may be closed.

When taking the hearing aid apart the battery drawer 30 is initially pulled off the pin 43, and the drawer 30 may now be used in that the lower most edge 33 of a lid part 34 is introduced as a wedge between the microphone cover plate 20 and the chassis 40 in a wedge shaped recess 28 provided between the cover plate 20 and the chassis 40 at the front end 22 of the cover plate 20. The recess 28 is best seen in FIG. 15. By introducing a wedge into this recess 28, a strong force will be applied to the microphone cover plate 20 in the up-ward direction, forcing snap projections 24, 25 to bend inwardly and release their hold on the two sides of the shell part 10. Once the cover plate 20 has been released from its hold onto the inside of the shell 10 it is relatively easy to slide the chassis 40 with the remaining parts out of the shell 10. The ease by which the battery drawer 30 and the cover plate 20 and the shell 10 is released from the remaining hearing aid parts is important as this allows colour versioning whereby shell, cover plate and battery drawer is chosen according to the users liking, to take place at a dispenser shop. And thereby the dispenser may present a large assortment of ready to wear hearing aids without buying more than a few of the more expensive inside assemblies.

1. Hearing aid or audio device having a behind the ear part adapted to rest behind an earlobe of a user and a speaker unit comprising a speaker, whereby the speaker unit is adapted for insertion into the ear of a user, and whereby electric leads are provided between the speaker unit and the behind the ear part, said leads having a connection part opposite the speaker unit for connection with a corresponding socket in the behind the ear part, wherein the exterior and visible parts of the behind the ear part are defined by a generally U-shaped shell element, a battery drawer and a microphone cover plate characterized in that all further inside parts of the behind the ear part are interconnected to form a single sub-assembly and in that said sub-assembly is releasably coupled to the U-shaped shell element between two upright walls thereof by latch-locks provided to interact between the microphone cover plate and the upright wall elements.

2. Hearing aid as claimed in claim 1, wherein snap latches are provided on an under-side of the microphone cover plate and where the up-right walls of the U-shaped shell element comprise undercuts at the inside rims thereof provided to receive the snap latches of the microphone cover plate.

3. Hearing aid as claimed in claim 2, wherein a wedge shaped recess is provided between the microphone cover plate and the remaining hearing aid, adapted to receive a wedge shaped implement in order to exert an opening force between the microphone cover plate and the hearing aid sufficient to force the snap latches of the microphone cover plate out of engagement with the undercuts of the inside rim of the shell element.

4. Hearing aid as claimed in claim 3, wherein a battery drawer is detachably connected to the hearing aid adjacent to the microphone cover plate, and whereby the battery drawer comprise a wedge shaped implement at an edge thereof shaped to fit into the wedge shaped recess between the microphone and cover plate.

5. Wireless antenna shaped as a coil comprising
an insulated electrically conductive wire wound in parallel coaxial windings defining a coil axis thereby adapted to transduce between changes in a magnetic field inside of the coil and electric power in the coil windings whereby further
a shield adapted to prevent electric fields from reaching the antenna is provided externally of the coil characterized in that
the shield in the direction transversely to the direction of the coil axis comprise at least two layers of electric leads,
where further the leads are interconnected, spaced apart and in each layer has a main direction of extension coaxially with the axis of the coil.

6. Wireless antenna as claimed in claim 5, wherein each lead in a first layer is placed to cover open space between leads (103) in a second layer and vice versa.

7. Wireless antenna as claimed in claim 6, wherein the leads transversely to their main direction of extension in a layer are wider than the space between two consecutive leads in the layer.

8. Wireless antenna as claimed in claim 5, wherein the wire wound up to form the coil at each end of the coil is connected to a printed circuit board, and whereby the leads of the shield are connected to the same printed circuit board.

9. Wireless antenna as claimed in claim 8 whereby the circuit board further comprise:
microphones being connected thereto,
an audio processor and audio amplifier,
output connections adapted to transmit an enhanced audio signal to an output transducer for delivering an audio signal to a user perceivable as sound,
power input means adapted to receive power from a battery.

10. Hearing aid or audio device having a behind the ear part adapted to rest behind an earlobe of a user and a speaker unit comprising a speaker, whereby the speaker unit is adapted for insertion into the ear of a user, and whereby electric leads are provided between the speaker unit and the behind the ear part, said leads having a connection part opposite the speaker unit for connection with a corresponding socket in the behind the ear part, whereby further the hearing aid comprise a wireless antenna as claimed in any of claims 5-9.
